(19) United States
(12) Patent Application Publication
(10) Pub. No.: US 2013/0179719 A1
(43) Pub. Date: Jul. 11, 2013

(54) POWER SUPPLY SYSTEM AND METHOD

(71) Applicants: HSIANG-PIN TSENG, Tu-Cheng (TW); MIN-WEI LEE, Tu-Cheng (TW)

(72) Inventors: HSIANG-PIN TSENG, Tu-Cheng (TW); MIN-WEI LEE, Tu-Cheng (TW)

(73) Assignee: HON HAI PRECISION INDUSTRY CO., LTD., Tu-Cheng (TW)

(21) Appl. No.: 13/603,520

(22) Filed: Sep. 5, 2012

(30) Foreign Application Priority Data
Jan. 6, 2012 (TW) 101100734

(51) Int. Cl. G06F 1/26

(52) U.S. Cl. 713/340; 713/300

(57) ABSTRACT

An exemplary power supply system for feeding electric power to an electronic device is provided. The power supply system includes an internal battery installed inside the electronic device and an external battery connected to the internal battery through a first switch. When the internal battery is above a set energy level, the first switch is turned off and the internal battery outputs electric power to the electronic device. When the internal battery falls below the first set energy level, the first switch is turned on and the external battery outputs electric power to the electronic device. A power supply method based upon the power supply system is also provided.

### REFERENCE TO RELATED APPLICATIONS

This application claims all benefits accruing under 35 U.S.C. §119 from Taiwan Patent Application No. 101100734, filed on Jan. 6, 2012 in the Taiwan Intellectual Property Office. The contents of the Taiwan Application are hereby incorporated by reference.

### BACKGROUND

1. Technical Field

The disclosure generally relates to power supply systems and methods, and particularly relates to power supply systems and methods for feeding electric power continuously to electronic devices.

2. Description of Related Art

Portable electronic devices, such as laptop computers, smartphones and portable media players, are often equipped with rechargeable batteries or disposable batteries for providing electric power to the portable electronic devices. However, when the batteries run out of power during data processing, transmitting, or other high-speed computing operations with the portable electronic devices, the sudden power outage can easily result in data corruption and even damage hardware components of the portable electronic devices.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of a power supply system for feeding electric power to an electronic device according to one embodiment.

FIG. 2 is a detailed functional block diagram of the power supply system of FIG. 1.

FIG. 3 is a flowchart of a power supply method for feeding electric power to an electronic device according to one embodiment.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blu-Ray discs, Flash memory, and hard disk drives.

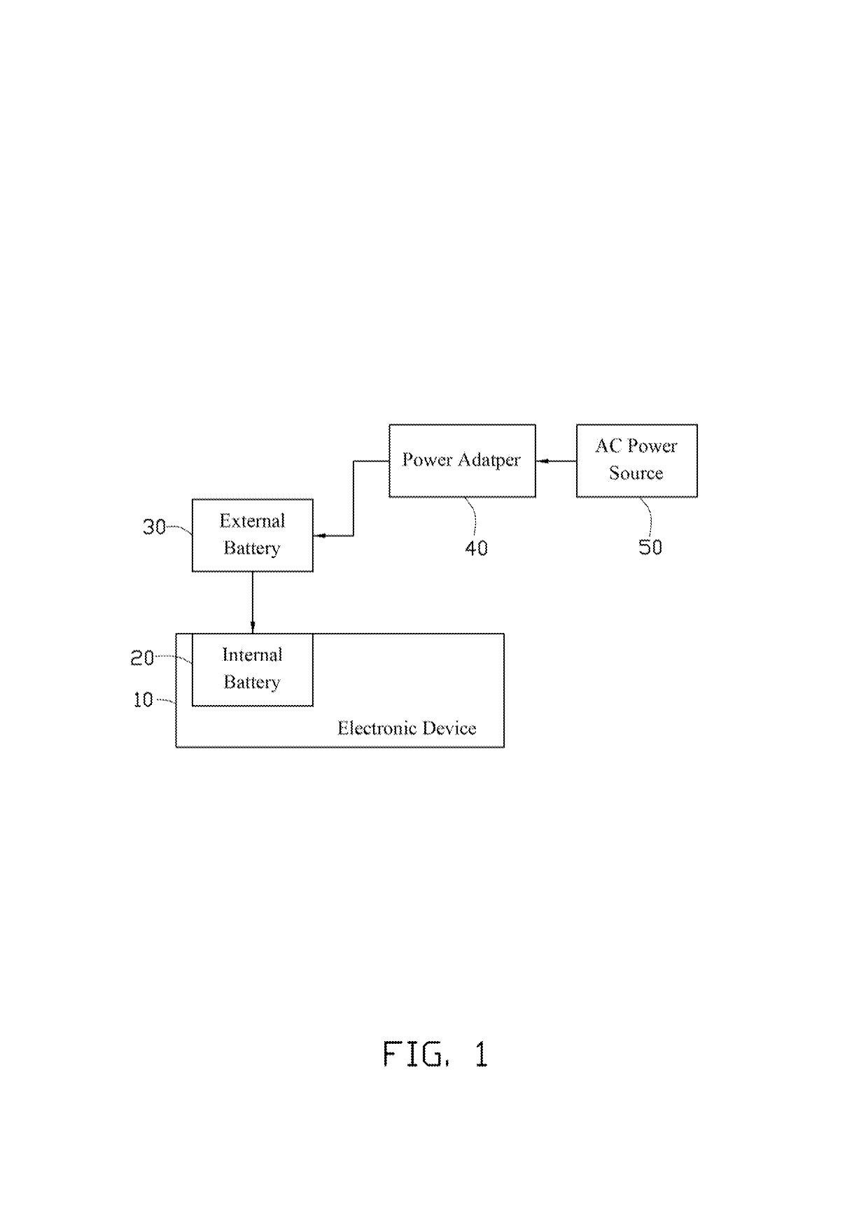

FIG. 1 shows a power supply system for feeding electric power to an electronic device 10 according to one embodiment. The power supply system includes an internal battery 20 installed inside the electronic device 10, and an external battery 30 connected to the internal battery 20.

In some embodiments the external battery 30 is a rechargeable battery. The power supply system further includes a power adapter 40 and an alternating current (AC) power source 50. The power adapter 40 interconnects the external battery 30 and the AC power source 50. The power adapter 40 may convert AC power output from the AC power source 50 into direct current (DC) power. Thus, the AC power source 50 may charge the external battery 30.

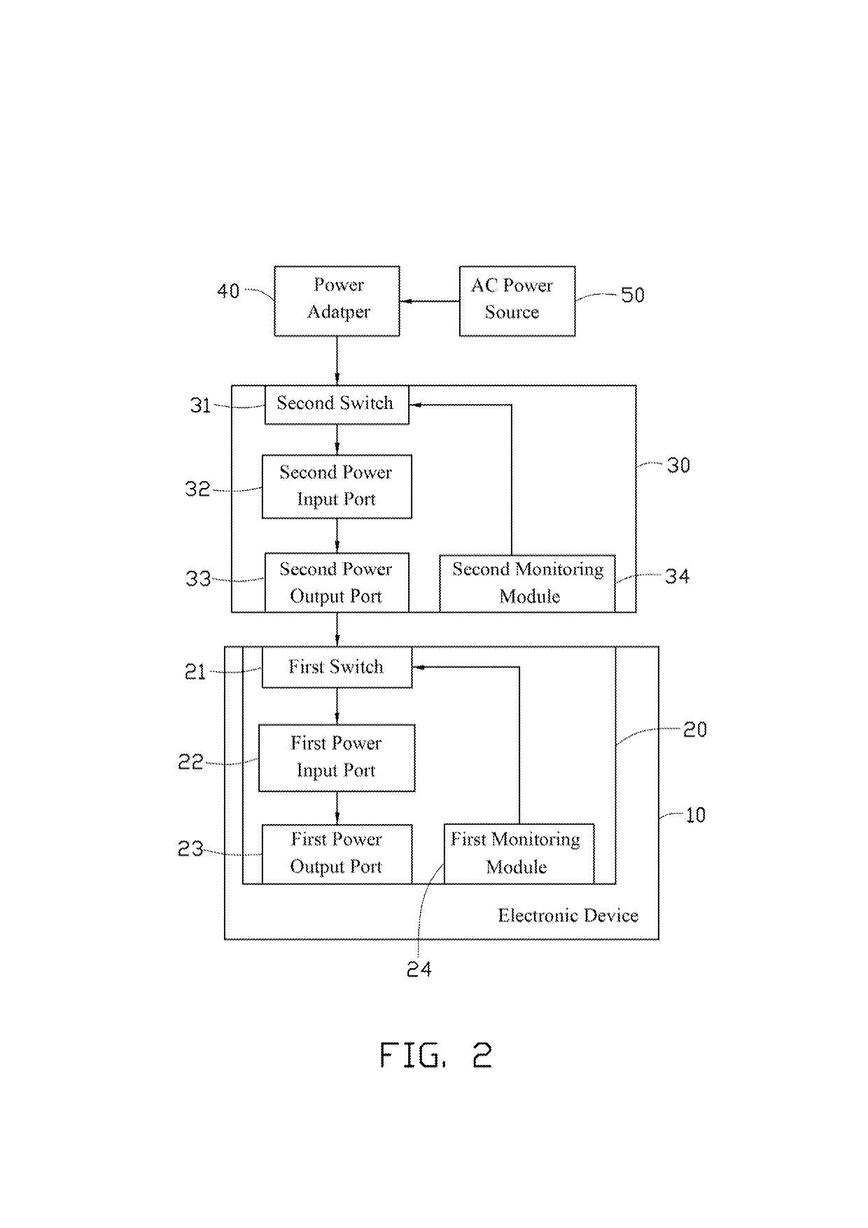

Referring to FIG. 2, the internal battery 20 of the embodiment is shown. The internal battery 20 includes a first switch 21, a first power input port 22 connected to the first switch 21, a first power output port 23 connected to the first power input port 22, and a first monitoring module 24 connected to the first switch 21.

The first monitoring module 24 may monitor the energy status of the internal battery 20 and turn on/off the first switch 21 based on the energy status of the internal battery 20. The first monitoring module 24 may determine whether the internal battery 20 falls below a first set energy level, e.g., 10 percent of energy left.

The external battery 30 includes a second switch 31, a second power input port 32 connected to the second switch 31, a second power output port 33 connected to the second power input port 32, and a second monitoring module 34 connected to the second switch 31.

The second monitoring module 34 may monitor the energy status of the external battery 30 and turn on/off the second switch 31 based on the energy status of the external battery 30. The second monitoring module 34 may determine whether the external battery 30 falls below a second set energy level, e.g., 15 percent of energy left.

The first switch 21 interconnects the second power output port 33 of the external battery 30 and the first power input port 22 of the internal battery 20. The second switch 31 interconnects the power adapter 40 and the second power input port 32 of the external battery 30.

When the first monitoring module 24 detects that the internal battery 20 falls below the first set energy level, the first monitoring module 24 turns on the first switch 21. The external battery 30 outputs electric power successively through the second power output port 33, the first switch 21, the first power input port 22, and the first power output port 23, and eventually to the electronic device 10. When the first monitoring module 24 detects that, the internal battery 20 is above the first set energy level, the first monitoring module 24 turns off the first switch 21. The external battery 30 cannot provide electric power to the electronic device 10 anymore. Thus, the internal battery 20 takes over and provides electric power to the electronic device 10 through the first power output port 23.

When the second monitoring module 34 detects that the external battery 30 falls below the second set energy level, the second monitoring module 34 turns on the second switch 31. The AC power source 50 outputs AC power to the power adapter 40. The power adapter 40 converts the AC power output from the AC power source 50 into DC power and then outputs the DC power to the external battery 30 to charge the external battery 30. When the second monitoring module 34 detects that the external battery 30 is above a third set energy level, e.g., 90 percent of energy left, the second monitoring module 34 turns off the second switch 31. Then the AC power source 50 stops charging the external battery 30.

In some embodiments, the internal battery 20 is a rechargeable battery. When the first monitoring module 24 detects that the internal battery 20 falls below the first set energy level, the external battery 30 may not only provide electric power to the electronic device 10, but also provide electronic power to the internal battery 20 to charge the internal battery 20.

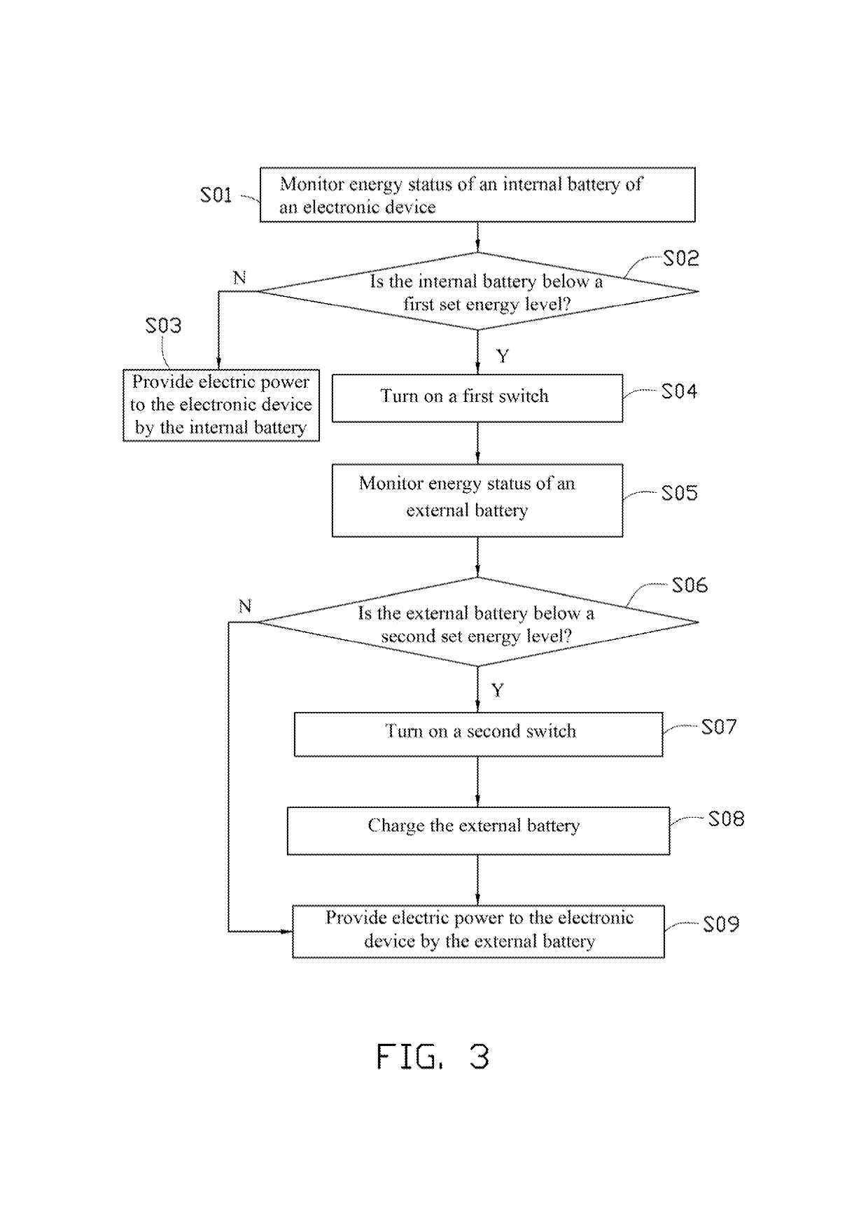

FIG. 3 is a flowchart showing one embodiment of a power supply method using the power supply system of FIG. 2. The method comprises the following steps.

In step S01, the first monitoring module 24 monitors the energy status of the internal battery 20.

In step S02, the first monitoring module 24 determines whether the internal battery 20 falls below the first set energy level. When the internal battery 20 is above the first set energy level, the flow goes to step S303. When the internal battery 20 falls below the first set energy level, the flow goes to step S304.

In step S03, the internal battery 20 outputs electric power to the electronic device 10 through the first power output port 23. The first switch 21 is turned off and the external battery 30 cannot provide electric power to the electronic device 10.

In step S04, the first monitoring module 24 generates a turn-on control signal to turn on the first switch 21. Thus, the external battery 30 can provide electric power to the electronic device 10.

In step S05, the second monitoring module 34 monitors the energy status of the external battery 30.

In step S06, the second monitoring module 34 determines whether the external battery 30 falls below the second set energy level. When the external battery 30 falls below the second set energy level, the flow goes to step S307. When the external battery 30 is above the second set energy level, the flow goes to step S309.

In step S07, the second monitoring module 34 generates a turn-on control signal to turn on the second switch 31.

In step S08, the power adapter 40 converts the AC power output from the AC power source 50 into the DC power and outputs the DC power to charge the external battery 30.

In step S09, the external battery 30 outputs electric power to the electronic device 10 successively through the second power output port 33, the first power input port 22, and the first power output port 23.

Although numerous characteristics and advantages have been set forth in the foregoing description of embodiments, together with details of the structures and functions of the embodiments, the disclosure is illustrative only, and changes may be made in detail, especially in the matters of arrangement of parts within the principles of the disclosure to the full extent indicated by the broad general meaning of the terms in which the appended claims are expressed.

In particular, depending on the embodiment, certain steps or methods described may be removed, others may be added, and the sequence of steps may be altered. The description and the claims drawn for or in relation to a method may give some indication in reference to certain steps. However, any indication given is only to be viewed for identification purposes, and is not necessarily a suggestion as to an order for the steps.

What is claimed is:

1. A power supply system for feeding electric power to an electronic device, the power supply system comprising:
an internal battery installed inside the electronic device, the internal battery comprises a first power output port, a first power input port connected to the first power output port, and a first switch connected to the first power input port; and
an external battery comprising a second power output port connected to the first switch;
wherein when an energy level of the internal battery is equal to or higher than a first set energy level, the first switch is configured to be turned off and the internal battery outputs electric power to the electronic device; when the energy level of the internal battery is lower than the first set energy level, the first switch is configure to be turned on and the external battery outputs electric power to the electronic device.

2. The power supply system of claim 1, wherein the internal battery further comprises a first monitoring module connected to the first switch, the first monitoring module is adapted to monitor the energy level of the internal battery and to turn on or off the first switch according to the energy level of the internal battery.

3. The power supply system of claim 2, wherein the first monitoring module is adapted to determine whether the energy level of the internal battery is equal to or higher than the first set energy level, to turn off the first switch when the energy level of the internal battery is equal to or higher than the first set energy level, and to turn on the first switch when the energy level of the internal battery is lower than the first set energy level.

4. The power supply system of claim 1, further comprises a power adapter interconnecting the external battery and an alternating current (AC) power source, the power adapter is adapted to convert AC power output from the AC power source into direct current (DC) power.

5. The power supply system of claim 4, wherein the external battery comprises a second switch connected to the power adapter; when the second switch is turned on, the AC power source charges the external battery; when the second switch is turned off, the AC power source stops charging the external battery.

6. The power supply system of claim 5, wherein the external battery further comprises a second power input port connected to the second switch, and a second power output port connected to the second power input port; the second power output is further connected to the first switch of the internal battery.

7. The power supply system of claim 6, wherein the external battery further comprises a second monitoring module connected to the second switch, the second monitoring module is adapted to monitoring an energy level of the external battery and to turn on or off the second switch according to the energy level of the external battery.

8. The power supply system of claim 7, wherein the second monitoring module is adapted to turn on the second switch when the energy level of the external battery is lower than a second set energy level, and to turn off the second switch when the energy level of the external battery is equal to or higher than a third set energy level.

9. The power supply system of claim 1, wherein the external battery is further adapted to output electric power to charge the internal battery when the energy level of the internal battery is lower than the first set energy level.

10. A power supply method for feeding electric power to an electronic device, the power supply method comprising:
connecting an external battery to an internal battery of the electronic device, wherein the external battery is connected to a first power input port of the internal battery through a first switch of the internal battery;
monitoring an energy level of the internal battery;
determining whether the energy level of the internal battery is lower than a first set energy level;
turning off the first switch and enabling the internal battery to provide electric power to the electronic device when the energy level of the internal battery is equal to or higher than the first set energy level; and
turning on the first switch and enabling the external battery to provide electric power to the electronic device when the energy level of the internal battery is lower than the first set energy level.

11. The power supply method of claim 10, further comprising interconnecting the external battery and an alternating current (AC) power source with a power adapter; connecting the power adapter to a second power input port of the external battery through a second switch of the external battery, wherein the power adapter is adapted to convert AC power output from the AC power source into direct current (DC) power.

12. The power supply method of claim 11, further comprising monitoring an energy level of the external battery.

13. The power supply method of claim 12, further comprising turning on the second switch and enabling the AC power source to charge the external battery through the power adapter when the energy level of the external battery is lower than a second set energy level.

14. The power supply method of claim 13, further comprising turning off the second switch and stopping the AC power source charging the external battery when the energy level of the external battery is equal to or higher than a third set energy level.

15. The power supply method of claim 10, further comprising charging the internal battery by the external battery when the energy level of the internal battery is lower than the first set energy level.
